(19) United States
(12) Patent Application Publication
(10) Pub. No.: US 2008/0288393 A1
(43) Pub. Date: Nov. 20, 2008

(54) Credit Worthiness Rating Method

(76) Inventor: Alvin D. Toms, West Perth (AU)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/909,590

(22) PCT Filed: Mar. 24, 2006
(86) PCT No.: PCT/AU2006/000392

§ 371 Date: Jul. 9, 2008

(30) Foreign Application Priority Data
Mar. 24, 2005 (AU) 2005901441

(51) Int. Cl. G06Q 40/00; H04L 9/32; G06Q 50/00

(52) U.S. Cl. 705/38

(57) ABSTRACT

A method of providing a credit worthiness rating, comprises receiving an identifier of an electronic device, such as a telephone number (12). Information is associated with the identifier. An assessor device (14) determines a credit worthiness rating (16) based on the information associated with the received identifier.

### FIELD OF INVENTION

The present invention relates to rating the credit worthiness of an applicant for credit.

### BACKGROUND

Bad debt is a serious problem for credit providers including providers such as telecommunications network operators because payments for the services they supply are often made in arrears. This means that the operators are effectively lending their customers money to the value of the services they use in each bill cycle. Since this lending is unsecured, there is a natural tendency for customers who run up unmanageable debts to fail to make payment, thereby leaving the network operator with little chance of recovering the money they are owed and no choice but to bar the offenders from their network.

Once barred, bad debtors will frequently reapply to the same operator in the hope of regaining access to their network. Simple checks on the names or social security numbers of applicants against those of previous bad debtors have proved effective in identifying many potential repeat offenders. There are many simple ways to overcome such measures, however, such as reapplying in the name of a friend or family member, using a fake or stolen identity, or obfuscating an identity by deliberate misspelling.

For example, bad debtors may reapply using slight misspellings of the names they have previously used that are enough to evade automatic checks that are designed to uncover their payment histories but not so great that postal correspondence relating to the services they obtain are unable to reach them. Attempts to develop automated systems to detect such obfuscation have so far met with limited success because of the time complexity of performing the approximate matches that are required and the large number of false matches that usually result.

It should be noted that the ease with which bad debtors can apply for services using new identities is greater than expected because many bad debtors are not single individuals but are more or less tightly connected groups of individuals such as families or housemates. The phrase ‘bad debtors’ is therefore used not in the narrow sense of the single individual whose name happened to be associated with an account that went into debt but in the broader sense of the group of individuals who were associated with the debt.

It is in identifying such groups that the traditional approach of associating credit information with particular individuals' identities is inadequate because a group of bad debtors has several identities that it can use to repeatedly re-access sources of credit before they can be reliably identified.

### BRIEF SUMMARY OF THE INVENTION

According to one aspect of the invention there is provided a method of providing a credit worthiness rating, the method comprising:
receiving an identifier of an electronic device, wherein information is associated with the identifier; and
determining a credit worthiness rating based on the information associated with the received identifier.

According to another aspect of the invention there is a method of providing a credit worthiness rating comprising:
receiving an identifier of an electronic device, wherein the identifier is associated with a service provided in relation to the electronic device; and
determining a credit worthiness rating based on information associated with the received identifier.

Usually the service is provided in return for one or more payments. Typically the electronic device is a telephone and the identifier is the telephone number of the telephone. The service may be access to a telecommunications network.

In one embodiment the credit worthiness rating is also based on additional information that is not associated with any specific identifier.

According to another aspect of the invention there is a method of providing a credit worthiness rating comprising:
receiving a telephone number; and
determining a credit worthiness rating based on information associated with the telephone number.

Preferably the information associated with the telephone number is data on the use of the telephone and/or data on the payment behaviour for provision of the telephone service, and/or services supplied to the telephone, and/or transactions or payments made using the telephone.

According to a further aspect of the invention there is a method of providing a credit worthiness rating and verifying the identity of a credit applicant comprising:
receiving a telephone number and identifying information of the credit applicant;
determining a credit worthiness rating of the credit applicant based on information associated with the telephone number; and
verifying the identifying information using the received telephone number.

In one embodiment the credit applicant's identity details are compared to the telephone subscriber's identity details.

In a further embodiment, the credit applicant's identity details and the telephone subscriber's identity details are encoded prior to comparison using a non-invertible encoding.

In one embodiment the identity details are subject to normalisation procedures prior to comparison or encoding.

In one embodiment a user of the telephone is contacted to verify that they approve of a credit assessment being performed against their telephone number.

In one embodiment a user of the telephone is contacted to verify that they are aware that a credit assessment is being performed against their telephone.

In one embodiment a user of the telephone is contacted to verify that they are the person who is applying for credit.

In one embodiment the user of the telephone that is contacted is the telephone subscriber.

In one embodiment the user of the telephone that is contacted is the credit applicant.

In one embodiment the telephone number is used to verify that the telephone is in the possession of the person applying for credit.

In one embodiment the telephone number is for a mobile telephone and the credit applicant appears in person and presents their mobile telephone, the telephone number is dialed to determine whether the credit applicant's telephone is the same as the telephone corresponding to the number dialed.

In one embodiment the identity of the subscriber holding the telephone number is checked against the identity of the credit applicant.

According to another aspect of the present invention there is a method for mapping a telephone number to a representation of credit worthiness comprising:
receiving a telephone number; and
mapping the telephone number to a representation of a credit worthiness rating.

Preferably the mapping is performed by computing the representation of credit worthiness from information associated with the telephone number.

In one embodiment the information associated with the telephone number comprises information relating to payments made for services supplied to the telephone or the user or users of the telephone.

In another embodiment the information associated with the telephone number comprises information relating to the usage of the telephone.

In a further embodiment the information associated with the telephone number comprises information relating to transactions or payments made using the telephone.

The representation of credit worthiness may be computed by some form of predictive model.

In a preferred embodiment the predictive model is a neural network.

The representation may be an approve-disapprove recommendation. The representation may be an approve-disapprove-refer recommendation. The representation may take the form of a credit score. Typically the credit score is output following transformation and scaling.

According to the present invention there is a computer program for controlling a computer to perform any one of the methods described above.

Also according to the present invention there is a computer readable storage medium for storing the above defined computer program.

Further the invention provides for a computer device programmed to perform one of the above defined methods.

According to one aspect of the invention there is an apparatus for providing a credit worthiness rating comprising:
means for receiving an identifier of an electronic device, wherein the identifier is associated with a service provided in relation to the electronic device; and
means for determining a credit worthiness rating based on information associated with the received identifier.

According to another aspect of the invention there is an apparatus for providing a credit worthiness rating comprising:
means for receiving a telephone number; and
means for determining a credit worthiness rating based on information associated with the telephone number. According to a further aspect of the invention there is an apparatus for providing a credit worthiness rating and verifying the identity of a credit applicant comprising:
means for receiving a telephone number and identifying information of a credit applicant;
means for determining a credit worthiness rating of the credit applicant based on information associated with the telephone number; and
means for verifying the identifying information using the received telephone number.

According to another aspect of the present invention there is an apparatus for mapping a telephone number to a representation of credit worthiness comprising:
means for receiving a telephone number; and
means for mapping the telephone number to a representation of a credit worthiness rating.

According to a further aspect of the present invention there is a system for providing a credit worthiness rating comprising:
means for receiving an identifier of an electronic device, wherein information is associated with the identifier; and
means for determining a credit worthiness rating based on the information associated with the received identifier.

### DESCRIPTION OF DIAGRAMS

In order to provide a better understanding of the present invention preferred embodiments will now be described in greater detail, by way of example only, with reference to the accompanying diagrams, in which:

FIG. 1 is a schematic block diagram of a system for providing a credit worthiness rating according to a preferred form of the present invention;

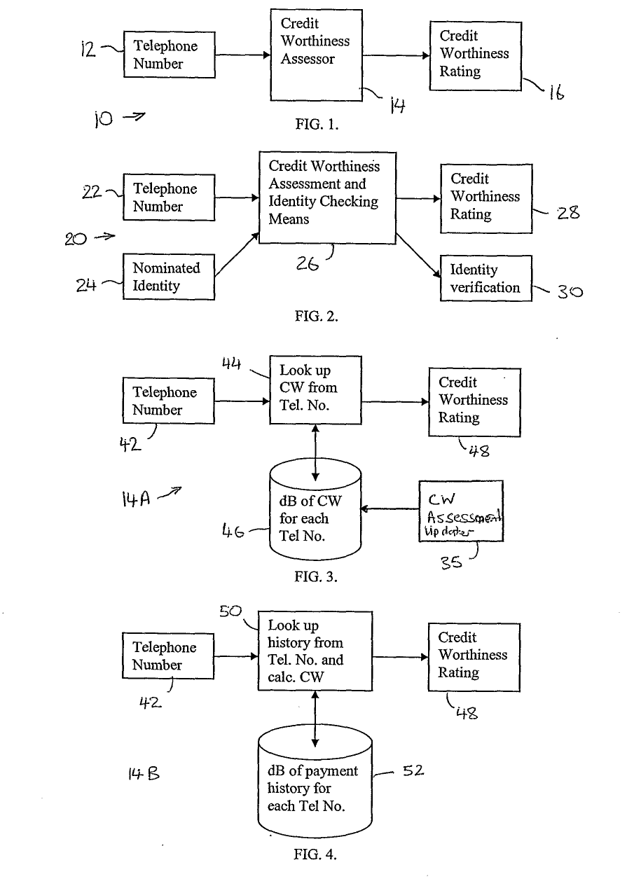

FIG. 2 is a schematic block diagram of a system for providing a credit worthiness rating and identity confirmation according to another preferred form of the present invention;

FIG. 3 is a schematic block diagram of a system for assessing credit worthiness rating according to one embodiment of the present invention;

FIG. 4 is a schematic block diagram of a system for assessing credit worthiness rating according to another embodiment of the present invention;

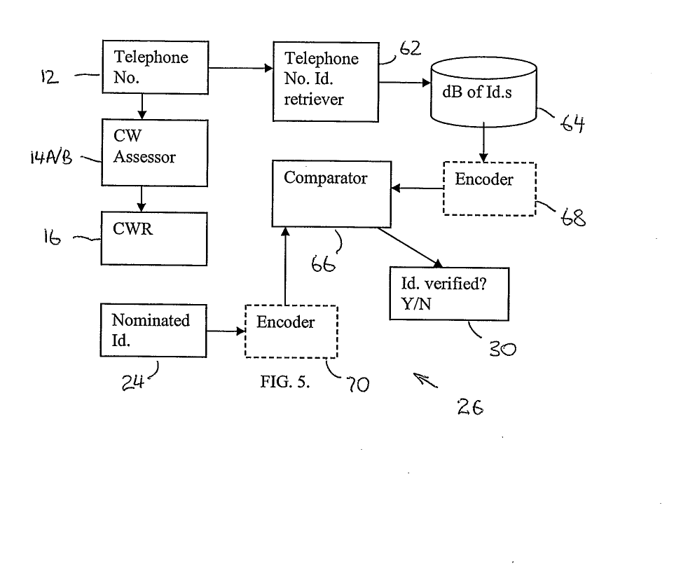

FIG. 5 is a schematic block diagram of a system for assessing credit worthiness rating and identity confirmation according to another embodiment of the present invention;

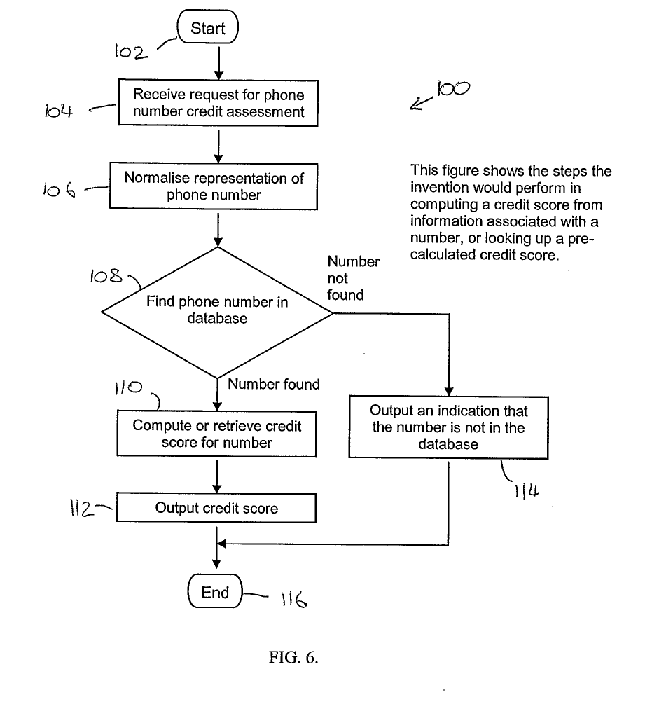

FIG. 6 is a schematic flow chart of one embodiment of a method of providing a credit worthiness rating according to the present invention; and

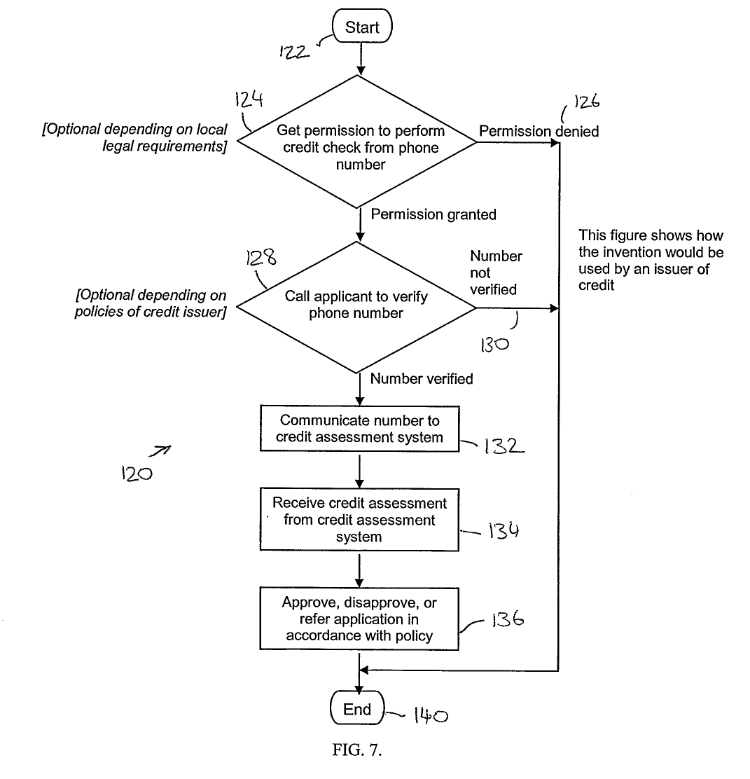

FIG. 7 is a schematic flow chart of another embodiment of a method of providing a credit worthiness rating according to the present invention.

### DETAILED DESCRIPTION OF PREFERRED EMBODIMENTS

The present invention estimates the credit worthiness of applicants for credit from a credit provider including applicants for services such as those supplied by a telecommunications operator by the unexpected realisation that one can exploit the fact that people are reluctant to change their telephone numbers. Most telephone numbers are closely associated with a specific person or group of people for long periods. This means that information associated with a telephone number typically describes the person or group of people who are normally associated with the telephone, and their behaviour.

Much of this information, such as the history of payments made for services supplied to the telephone, the types of services requested, and the manner of their use, can be used to estimate the credit worthiness of the phone's users. For example, if the costs of services supplied to a telephone are high but payments are always full and prompt, it is likely that the users of the phone will also be reliable in the repayment of credit. If, on the other hand, the cost of services is low or erratic and payments are frequently late or partial, then the users of the phone are likely to represent a poor credit risk.

This is also applicable to identifiers of electronic devices other than telephones, such as conventional, portable, or handheld computers, personal organisers, smartcards (including smart identity cards and credit cards), electronic identification tags (including RFID tags), and electronic components within these devices, such as network cards and processing units. In the case of computing devices with network connectivity the service could consist of internet access and the identifier could be an internet protocol address. In the case of the identity card or smart card, the service could be the provision of social welfare, banking or credit facilities. Identification tags may be used as a substitute for identity cards. Identifiers associated with components of electronic devices such as computing devices may be used as an identifier for the entire device. For example, a computer on a network may be identified by the MAC address of its network card or the serial number of its processor. In general, the invention will work with any identifier of any electronic device that tends to be associated with one or more specific people for extended periods.

Referring to FIG. 1, a simplified form of a system 10 for providing a credit worthiness rating or representation is shown. It includes an input means 12 for receiving an identifier (such as a telephone number), a credit worthiness assessor 14 and an output means 16 for providing a rating of credit worthiness based on the input telephone number. The input means 12 will usually be in the form of a keyboard connected to a computer system.

The credit worthiness assessor will usually be in the form of a second computer system connected to the first computer system by a network. The first computer system will be arranged to provide the inputted telephone number to the second computer system, which will determine the credit worthiness rating as will be described below. The second computer system is arranged to provide the determined credit worthiness rating to the first computer system. The output means will usually be in the form of a display screen of the first computer system. It will be appreciated that the roles of the first and second computer systems could be performed by a single computer system or by many computer systems.

The computer systems which perform the method described herein operate under the control of one or more computer programs that configure and direct the computer systems to perform the invention. The computer program(s) may be stored on a computer readable storage medium, such as an installed memory device or a disk drive for access by the computer processor during operation, or on a removable medium, such as a floppy disk, CD, DVD, flash memory stick, etc. for loading onto the computer system.

Referring to FIG. 2, a simplified form of a system for providing credit worthiness and identity verification 20 is shown. It includes an input means 22 for receiving an identifier (such as a telephone number), an input means 24 for receiving a nominated identity, a credit worthiness and identity checking means 26, an output means 28 for providing a rating of credit worthiness based on the input telephone number, and an output means 30 for providing an indication of whether the identity nominated is verified based on the telephone number supplied. The typical embodiment of this system will be the same as that described in relation to FIG. 1, with the keyboard forming both input means 22 and 24, the computing device(s) forming the credit worthiness and identity checking means 26, and the display screen forming the output means 28 and 30.

Referring to FIG. 3, one form of credit worthiness assessor 14A is shown, which comprises a receiver 42 for receiving the telephone number from the input means 12. The receiver 42 is arranged to hand the telephone number to a lookup means 44. The lookup means 44 is configured to accesses a storage means 46 in which is stored a database of credit worthiness ratings to which telephone numbers in the system are mapped. The storage means may form part of the first or second computer system or may be external. The lookup means 44 is configured to retrieve the credit worthiness rating corresponding to the telephone number. The lookup means 44 is arranged to transmit the retrieved credit worthiness rating to the output means 16 using transmitter 48.

The database stored in the storage means 46 is updated by a credit worthiness database updater 35. The updater 35 may be implemented in the second computer system or may be external to the system 10.

Referring to FIG. 4, another form of credit worthiness assessor 14B is shown. This assessor 14B comprises a receiver 42 for receiving the telephone number from the input means 12. The receiver 42 is arranged to hand the telephone number to a lookup means 50. The lookup means 50 is configured to access a storage means 52 in which is stored a database of information associated with each telephone number in the system. The lookup means 50 is configured to retrieve the information associated with the telephone number. The lookup means is further configured to calculate a credit worthiness rating based on the retrieved information details. Optionally, additional information may also be used to calculate the credit worthiness rating. This information could include representations of credit worthiness derived by conventional credit worthiness assessment means, which may improve the accuracies of the assessments made by the present invention if they are based on data that the invention cannot access directly. The additional information need not be associated with any specific telephone number and may, for example, include economic projections, which might provide a useful indication of the likely future trends of default rates. The lookup means 50 is arranged to transmit the calculated credit worthiness rating to the output means 16 using transmitter 48.

Referring to FIG. 5, which shows the credit worthiness and identity checking means 26 in more detail. The credit worthiness and identity checking means 26 comprises a credit worthiness assessor (14A or 14B), a means for retrieving the identity 62 serviced by the telephone number (usually the account holder) and a comparator 66. The means for retrieving the identity 62 will usually be in the form of an identity requesting means and an identity retrieving means. A telecommunications company will usually operate the identity retrieving means, whereas the credit provider will usually operate the identity requesting means (especially if they are not the same entity). The identity requesting means is configured to request the identity serviced by the telephone number from the identity retrieving means. Upon receipt of this request, the identity retrieving means is configured to access a database stored on a storage means 64 and retrieve the identity details (name, address, etc.) from the database and to send it to the comparator 66. The comparator 66 compares the identity provided by input means 24 with the identity provided by the identity retrieving means. In the event that the identities match a positive indication is provided to the output means 30. In the event that the identities do not match a negative indication is provided to the output means 30.

The comparator 66 may be configured to provide an indication of a partial match to the output means 30, when the identity details partially match. For example, the telephone account may be in the name of one family member, but the credit applicant is a different person residing in the same residence or having the same surname. A partial match may be given in those circumstances. Details of the extent of the match may also be given.

Privacy laws or concerns may be addressed by the telecommunications company encoding the identity retrieved from the database by using an encoder 68. The encoder can use a suitable technique, such as hashing, to obtain data representing the identity. The data may not be reversible back to the identity, but would be created in a manner such that it would be highly unlikely that a different identity being encoded would create the same data. The operator of the credit facility would encode the identity details provided by the applicant using encoder 70, using the same encoding technique, in order to compare the resulting data. To improve the robustness of the comparison, identity information can be subject to a series of normalisation procedures prior to encoding, such as converting text into a phonetic representation in order to minimise the effects of misspelling by data entry operators. A sophisticated comparator and encoder arrangement may be able to determine a degree of match from the encoded identity details.

Referring to FIG. 6, the method of use of one embodiment of the present invention using the system of FIG. 1 will now be described. The credit applicant will have requested a credit facility, such as the provision of a service for which payments are made in arrears, the provision of a product for which late payments are made, or a conventional credit facility such as a loan. As an example of credit taking the form of the provision of a service, telecommunications and internet service providers usually demand payments in arrears, effectively issuing credit to the value of the services they supply. As part of the credit application process the credit applicant supplies their telephone number (which may be for a land line or a mobile telephone) at 102. This is entered into the input means 12.

The credit worthiness assessor 14 may normalise 106 the format of the number to eliminate possible confusions that can occur when the same number can be represented in several different ways.

For example, the same telephone number can typically be given at the level of the local exchange (for example, 534489), at the level of the regional exchange (for example, 01477534489) or at the level of national interconnect (for example 00441477534489). This normalisation process can be performed using industry standard techniques that are based on segmenting the number to identify missing elements that can then be supplied from lookup tables. The normalisation step may not be necessary if the telephone numbers used by the invention are likely to be in a consistent format.

The credit worthiness rating is obtained using one of the two embodiments of FIGS. 3 and 4. This also functions as a check at 108 to determine whether the telephone number is in the database (46 or 52). If the telephone number is not in the database an output is provided at 114 to the output means 16 indicating that the number is not in the database. Other credit worthiness rating techniques may still be used to provide a credit worthiness rating. Failure to find the number in the database may be sufficient to provide a credit rating according to the policies of the operator of the rating system, in which case, the system will proceed to step 112.

If the embodiment of FIG. 3 is used an indication of credit worthiness is already associated with the normalised telephone number in the storage device 46. It is retrieved by the lookup means 44 at step 110.

If the embodiment of FIG. 4 is used the lookup means 50 retrieves the information associated with the telephone number from the storage means 52 and computes an indication of credit worthiness at step 110.

The essential difference between these two approaches is that the first requires a representation of credit worthiness already to be associated with the normalised telephone number in a storage device. The source of the representation could be external to the invention, and could consist of a conventional credit scoring mechanism.

The credit worthiness rating is then provided 112 to the output means 16. The credit worthiness rating is an indication of the credit worthiness of the person or group of people that use the telephone.

A configuration of the invention that would provide an indication of credit worthiness by association could be simply to respond to a query about a telephone number with an indication as to whether money is owed against services supplied to the telephone. This information would be supplied by an external agent using updater 35 and stored against the telephone number in a storage device 46; the invention would simply provide the output means 16 with an indication of poor credit worthiness if money is owed or overdue and good credit worthiness otherwise. The invention in this case provides a simple good-bad binary output that indicates whether or not credit should be issued to the credit applicant. This is referred to as rating by association because the indication of credit worthiness is explicitly present and associated with the telephone number in the storage device.

Where an indication of credit worthiness is generated by computation, information such as the usage of a telephone, payments made against services supplied to the telephone, and information about how long it has been since the telephone number was last re-assigned can be associated with the telephone's number in a storage device, and can all be used in conjunction or in isolation to derive indications of credit worthiness using a variety of different credit worthiness estimators.

For example, a scorecard approach to computing credit worthiness estimates from such information would consist of collecting a large number of exemplar records representing individual telephones, each record containing the above mentioned information, and labelling each record according to whether it represents a good or bad credit risk, depending on whether there is unrecoverable debt associated with it. This exemplar set can then be used in conjunction with industry standard techniques to produce a linear scorecard, which can provide a continuous non-binary indication of the credit worthiness of the user or group of users of any telephone number for which the same information is available.

A preferred embodiment of the present invention uses a non-linear neural network instead of the linear scorecard. Neural networks can be created from the same data sets as traditional linear scorecards but their capacity to model the non-linearities that are intrinsic in the determination of accurate estimates of credit worthiness means that they almost always offer superior performance. An additional benefit of using neural networks is that their outputs can be interpreted as posterior probabilities, which means that they can be given a precise objective interpretation as a representation of the actual likelihood of a bad debt occurring, in a way that the outputs of linear scorecards cannot.

These examples of calculating the credit worthiness rating are provided by way of example only and there are many alternative ways in which the invention can be implemented in practice. For example, in any specific application there may be more or less information associated with a telephone number than has been described above; the payment history could be summarised by nothing more than the outstanding balance, or it could contain a complete history of bill amounts, payment amounts, bill dates, payment dates, and payment methods.

Behavioural information relating to the use of the telephone itself can also be used. For example, whether the telephone is used to call gaming services or ‘hot’ destinations that are favoured by fraudsters and bad debtors can provide an indication of credit worthiness, as can the locations of cell sites that calls are made from and to, and the type and frequency of m-commerce transactions.

Credit worthiness assessments derived from information indirectly associated with a telephone number can also be included. For example, conventional credit worthiness assessments derived from the credit history of the subscriber associated with the telephone number provided by a credit applicant may be used by the invention in conjunction with other information to produce enhanced credit assessments.

Information that is not specific to any particular telephone number can also be used. For example, econometric projections may provide an indication of deteriorating economic conditions that can increase the risk of payment defaults.

All of these data types can easily be accommodated by the invention and used to enhance the accuracies of its assessments.

Similarly, estimates of credit worthiness can be derived in a variety of different ways in addition to the linear scorecards and neural networks that have already been described. For example, credit worthiness estimates may be derived from other types of predictive models that are trained on exemplar data, including support vector machines and similar machine learning methodologies, nearest neighbour classifiers, and Gaussian processes. Alternatively, credit worthiness estimates may be produced by systems that are not trained on exemplar data but have been created by human experts. For example, credit analysts could create sets of fuzzy or crisp rules for the purposes of producing credit worthiness estimates:

IF

outstanding_balance > USD$200
AND current_date − due_date > 30 days

THEN

credit_worthiness IS low

Changes to the types of data available to the invention and the types of credit worthiness estimators used within it do not change the fundamental operating principal of the invention. In fact, it is expected that different types of data will naturally be available to the invention in different applications, and different types of credit worthiness estimators will have to be used within it. For example, some users of the invention may not have exemplar data with which to train predictive models and will therefore have to use a credit estimator that does not require exemplar data. Similarly, different users of the invention will associate different amounts of information with a telephone number and will therefore be forced to use different information in deriving credit worthiness estimates. For example, some users may record very rich telephone usage behaviour statistics for each phone number whereas some may only record payment behaviour summary statistics.

The present invention is applicable to estimating credit worthiness from an identifier and its application is not restricted purely to approving credit within the telecommunications domain. The invention is applicable anywhere where credit worthiness assessments are required and credit applicants can provide an identifier of an electronic device that is normally consistently associated only with a specific single individual or a specific group of people.

It should also be noted that the invention can provide an indication of credit worthiness that takes into account both bad debtors and application fraudsters since both groups typically wish to retain the same phone number for extended periods. The invention therefore has applications in reducing bad debt that results from both unintentional and intentional (fraudulent) non-payment, and the term ‘bad debtors’ is herein intended to include individuals and groups of individuals who fail to repay credit, regardless of whether the failure is intentional or unintentional.

The format of the credit worthiness rating may vary from a simple binary good or bad to a complex discrete or continuous rating system as used by other commercial credit rating systems. The invention may include means to convert one form of credit worthiness rating in to another format depending on the format required. For example, a neural network credit rating engine typically outputs a continuous representation of credit worthiness that may need to be converted into a discrete format if that is required for the invention to interface with the credit issuer's systems. Similarly, a neural network credit rating engine will typically output numbers representing credit worthiness estimates that lie in the range zero to one. Some users of the invention will need these to be scaled and transformed into another range, typically the range one to one thousand, to interface with the own systems. The invention may also allow for combining the credit rating derived from the credit applicant supplied telephone number with another assessment of credit worthiness resulting in a combined credit worthiness assessment.

The telephone number provided as part of the credit worthiness rating can also be used to verify the identity of the applicant or verify that they are authorised to obtain a credit rating against a phone, to reduce the instances of someone successfully bypassing the present invention by providing another person's telephone number.

This can be done in a variety of ways including contacting a user of the telephone to see whether they approve, authorise, or are aware that a credit check is to be made against their telephone number, or whether they know the applicant. The contact may be made by calling the number supplied by the credit applicant, sending a text message, or other means. In its simplest form, the number supplied by the credit applicant is called to see if the credit applicant has the phone in their possession.

A more complex form shown in FIG. 7 uses the system described in relation to FIG. 5. The process 120 starts at 122 where the credit applicant provides their telephone number and identity details (such as name and address). Depending on legal requirements it may be necessary to obtain the applicant's permission to perform a credit check at 124. If this is denied at 126 the process proceeds to the end 140 and the denial will be taken into account in determining whether an alternative verification process is possible or whether to provide the credit being sought. The credit provider may operate a policy whereby a denial is sufficient to determine credit worthiness, in which case, the process will proceed to step 136.

If permission is given, a further optional step may be taken. At step 128, the phone number is used to verify the identity of the credit applicant or verify that they are authorised to apply for credit using the number. This can be done in a variety of ways as described earlier. Again if the number is not verified the process proceeds to the end at 140 and this is again taken into account, unless failure to verify the number is sufficient to determine credit worthiness, in which case the process can proceed to step 136.

Next the number is communicated to the telephone number identity retriever 62 at step 132. The identity associated with the number is retrieved and provided to the comparator 66. The credit worthiness assessor 14 assesses the credit worthiness of the applicant at 134.

The output from the assessor 14 and the comparator 66 provide a credit worthiness rating and a verified (or partially verified or non-verified) identity. These are used at 136 to approve, disapprove or refer the credit application according to the credit provider's policy, or to generate some alternative representation of credit worthiness. The process ends at 140. In this arrangement of the invention, it is possible for the outcome of the identification verification process to affect the invention's assessment of credit worthiness. This can be useful because, for example, if the information associated with the phone number indicates that it has only a single user, failure to verify the identity of the credit applicant against the identity of the registered user of the phone may indicate a fraudulent attempt to access credit.

In an alternative arrangement of the invention, step 128 may involve contacting the registered user of the phone to see whether they approve, authorise, or are aware that a credit check is to be made against their telephone number, or whether they know the applicant. This contact may occur by calling the number supplied by the credit applicant, calling an alternative number associated with the registered user of the phone, using a text messaging service or alternative communication means such as the conventional postal system. This type of check may be useful in establishing that a phone has not been stolen.

The present invention has numerous advantages. Although bad debtors frequently obfuscate their names or use stolen identities to avoid detection, they usually wish to retain the same telephone number. This allows them to avoid the inconvenience of having to memorise a new number, and to inform all their contacts that their number has changed. Accordingly recording the presence of bad debt against the phone number of a bad debtor provides a way to identify potential bad debt risk when someone contacts either the same or a different network requesting a number that was previously used by a bad debtor.

Furthermore, the desire to retain a phone number is almost universal amongst good customers and hence recording the absence of bad debt against the number of a subscriber who leaves a network voluntarily may be equally useful to the same operator at a later date or a different operator if the subscriber is intending to switch networks. This persistent association of phone numbers with subscribers means that associating credit risk information with a phone number rather than the identity claimed by the user of a phone may provide a more robust way of tracking credit risk than those in use today.

The present invention can be used in developing countries where the information infrastructure is extremely limited, making it difficult to verify a person's identity and hence build meaningful credit histories. The credit worthiness assessments provided by the present invention are not necessarily specific to any single identifiable individual, and hence the invention does not provoke the same privacy concerns as more traditional credit scoring systems; depending on the configuration of the invention its credit ratings can represent the complex interactions of the ratings of all the people that use a telephone and who support payment for the services supplied to it.

The present invention is stronger than traditional credit worthiness methods in cases where the bad debtor is a group of individuals because there is increased resistance to applying for a service under a new telephone number when each member of a group has to be convinced to update all their contacts.

The present invention has applications in providing a credit worthiness rating for numerous forms of credit, the nature of which is not to be considered limiting.

The skilled addressee will readily appreciate that numerous modifications and variations may be made to the present invention without departing from the basic inventive concept. Such a modification may include:
using an electronic device identification number rather than the telephone number. For example an Internet Protocol (IP) address could be used where the IP address has an associated payment/use history with an internet service provider. In cases where a dynamic IP address is provided another unique identifier can be used such as a network interface card or microprocessor address/identifier (e.g. MAC address or processor serial number) This is particularly useful if the application for credit is conducted on-line, since the identifier can be automatically provided to the input means 12.
it is envisaged that convergence of telephone devices and personal computing devices will at some point eliminate the difference between a telephone number and a device address. For this reason an electronic device identifier is intended to include any identification of a device to which relevant information can be associated to make an assessment of credit worthiness.

All of those modifications and variations as would be apparent to the skilled addressee are intended to fall within the scope of the present invention, the nature of which is to be determined by the foregoing description and appended claims.

1-44. (canceled)

45. A method of providing a credit worthiness rating in relation to the provision of a credit facility to an applicant for a first product or service, the method comprising:
receiving an identifier of an electronic device associated with the applicant,
determining a credit worthiness rating in relation to the provision of credit for the first product or service based solely on credit worthiness relevant information associated with the received identifier,
wherein the provision of the first product or service includes products and services unrelated to the use of the electronic device.

46. A method as claimed in claim 45, wherein the identifier is a telephone number.

47. A method as claimed in claim 46, wherein a user of the telephone is contacted to verify that they are the person who is applying for the credit facility.

48. A method as claimed in claim 46, wherein the information associated with the telephone number comprises one or more of the following:
(i) information relating to payments made for services supplied to the telephone or the user or users of the telephone; and/or
(ii) information relating to the usage of the telephone; and/or
(iii) information relating to transactions or payments made using the telephone.

49. A method as claimed in claim 48, wherein the credit worthiness rating is computed from information associated with the identifier.

50. A method as claimed in claim 49, wherein the credit worthiness rating is computed by a predictive model.

51. A method as claimed in claim 45, wherein the credit worthiness rating is combined with other credit worthiness information to produce a composite credit worthiness rating.

52. A method as claimed in claim 46, wherein a user of the telephone is contacted to verify that they are aware that a credit assessment is being performed against the telephone.

53. A method as claimed in claim 52, wherein the user of the telephone that is contacted is the telephone subscriber.

54. A method as claimed in claim 46, wherein a user of the telephone is contacted to verify that they approve of a credit assessment being performed against the telephone number.

55. A method as claimed in claim 46, wherein the telephone number is used to verify that the telephone is in the possession of the person applying for credit.

56. A method according to claim 55, wherein the telephone number is for a mobile telephone and the credit applicant appears in person and presents their mobile telephone, the telephone number is dialed to determine whether the credit applicant's telephone is the same as the telephone corresponding to the number dialed.

57. A method of providing a credit worthiness rating in relation to the provision of a credit facility to an applicant for a first product or service, the method comprising:
receiving an identifier of an electronic device associated with the applicant, wherein the identifier is associated with a second service provided in relation to the electronic device;
determining a credit worthiness rating in relation to the provision of credit for the first product or service based solely on credit worthiness relevant information associated with the received identifier,
wherein the first product or service is different to the second service.

58. A method as claimed in claim 57, wherein the identifier is the telephone number.

59. A method as claimed in claim 57, wherein the second service is a telecommunications service.

60. A method of providing a credit worthiness rating in relation to the provision of a credit facility for a product or service other than the provision of a telephony service, said method comprising:
receiving a telephone number;
determining a credit worthiness rating in relation to the provision of credit for the product or service based solely on information associated with the telephone number, wherein the information is data related to the use of the telephone.

61. A method as claimed in claim 60, wherein the data related to the use of the telephone comprising one or more of the following: data on the use of the telephone, data on the payment behavior for provision of the telephone service or services provided to the telephone and/or information relating to transactions or payment made using the telephone.

62. A method of providing a credit worthiness rating and verifying the identity of a credit applicant comprising:
receiving a telephone number and identifying information of the credit applicant;
determining a credit worthiness rating of the credit applicant based on information associated with the telephone number;
retrieving an identifier of an account holder associated with the telephone number;
verifying the identifying information by comparing the identifier of the account holder to the received identifying information.

63. A method as claimed in claim 45, wherein the provision of the first product or service is unrelated to the use of the electronic device.

64. A method as claimed in claim 62, wherein the credit applicant's identifying information and the telephone account holder's identifier details are encoded prior to comparison using a non-invertible encoding.

65. A method according to claim 45, further comprising:
receiving the identifier at a credit provider system; sending the identifier to a credit assessor system; wherein the credit assessor system determines the credit worthiness rating from the identifier; and sending the credit worthiness rating to the credit provider system.

66. A method according to claim 65, wherein the assessor system is located remotely from the credit provider system.

67. A method according to claim 65, wherein the credit provider system is prevented from accessing the usage information associated with the identifier.

68. A method according to claim 45, further comprising:
receiving identity information from the applicant;
retrieving identity information associated with the identifier;
comparing the received identity information and retrieved identity information to output an identity comparison.

69. A method according to claim 68, further comprising: applying privacy encoding of the received identity information.
applying privacy encoding of the retrieved identity information; and
comparing the encoded received identity information to the retrieved identity information.

70. A method according to claim 45, further comprising:
establishing communication with the electronic device for communicating with the applicant to confirm the electronic device is in the applicant's possession.

71. A method according to claim 45, further comprising:
using a policy applicator to apply a credit policy to the credit worthiness rating to determine whether the credit facility is provided to the applicant.

72. A method according to claim 45, further comprising:
using a policy applicator to apply a credit policy to the credit worthiness rating and the identity confirmation to determine whether the credit facility is provided to the applicant.

73. A computer program for controlling a computer to perform a method as described in claim 45.

74. A computer program for controlling a computer to perform a method as described in claim 57.

75. A computer program for controlling a computer to perform a method as described in claim 60.

76. A computer program for controlling a computer to perform a method as described in claim 62.

77. A computer readable storage medium which stores the computer program defined in claim 73.

78. A computer readable storage medium which stores the computer program defined in claim 74.

79. A computer readable storage medium which stores the computer program defined in claim 75.

80. A computer readable storage medium which stores the computer program defined in claim 76.

81. A computer device programmed to perform the method defined in claim 45.

82. A computer device programmed to perform the method defined in claim 57.

83. A computer device programmed to perform the method defined in claim 60.

84. A computer device programmed to perform the method defined in claim 62.

85. An apparatus for providing a credit worthiness rating in relation to the provision of a credit facility for a first product or service, the apparatus comprising:
means for receiving an identifier of an electronic device;
means for determining a credit worthiness rating in relation to the provision of credit for the product or service based on information associated with the received identifier;
wherein the provision of the first product or service includes products and services unrelated to the use of the electronic identifier.

86. An apparatus for providing a credit worthiness rating comprising:
a credit provider system having means for receiving a telephone number from an applicant of a credit facility unrelated to a service provided in connection with the telephone number;
a credit assessor, having system means for determining a credit worthiness rating applicable to the credit facility based on usage information associated with the received telephone number;
a transmitter medium for sending the telephone number from the credit provider system to the credit assessor system and for sending the credit worthiness rating from the credit assessor system to the credit provider system, wherein the credit provider system outputs the credit worthiness rating or applies credit worthiness rating to a credit policy to determine whether the credit facility is provided to the applicant.

87. An apparatus for providing a credit worthiness rating and verifying the identity of a credit applicant comprising:
means for receiving a telephone number and identifying information of a credit applicant;
means for determining a credit worthiness rating of the credit applicant based solely on credit worthiness related information associated with the telephone number; and
means for verifying the identifying information using the received telephone number based solely on identity information associated with the telephone number.

88. An apparatus according to claim 85 further comprising a credit provider system, a credit assessor system, and transmission means for sending the identifier from the credit provider system to the credit assessor system and for sending the credit worthiness rating from the credit assessor system to the credit provider system, wherein the credit provider system has a receiver of the identifier, wherein the credit assessor system has an assessor for determining the credit worthiness rating.

89. An apparatus according to claim 88, wherein the credit assessor system is configured to prevent the credit provider system from accessing the usage information associated with the identifier.

90. An apparatus according to claim 85 further comprising:
means for receiving identity information from the applicant;
means for retrieving identity information associated with the identifier;
means for comparing the received identity information and retrieved identity information to output an identity comparison.

91. An apparatus according to claim 85 further comprising:
means for applying privacy encoding of the received identity information.

92. An apparatus according to claim 85 further comprising:
means for applying privacy encoding of the retrieved identity information and;
means for comparing the privacy encoded identity information(s).

93. An apparatus according to claim 85 further comprising:
means for establishing communication with the electronic device for communicating with the applicant to confirm the electronic device is in the applicant's possession.

94. An apparatus according to claim 85 further comprising:
a policy applicator for applying a credit policy to the credit worthiness rating to determine whether the credit facility is provided to the applicant.

95. An apparatus according to claim 85 further comprising:
a policy applicator for applying a credit policy to the credit worthiness rating and the identity confirmation to determine whether the credit facility is provided to the applicant.

96. A method of obtaining a credit worthiness rating in relation to the provision of a credit facility, the method comprising:
sending a telephone number to a credit worthiness rating system;
looking up a credit worthiness rating based solely on the received telephone number in a database of credit worthiness rating system; and
returning the credit worthiness rating.

97. A method of obtaining a credit worthiness rating in relation to the provision of a credit facility for a first product on service, the method comprising:
receiving a telecommunications device identifier;
calculating a credit worthiness rating from usage information of the telecommunications device identified and/or payment information for use of the telecommunications device identified.
